(19) United States
(12) Patent Application Publication
(10) Pub. No.: US 2026/0340151 A1
(43) Pub. Date: Oct. 29, 2026

(54) SYSTEMS AND METHODS FOR CYBERTHREAT FORECASTING

(71) Applicant: BP Corporation North America Inc., Houston, TX (US)

(72) Inventors: Chip E. Calhoun, Houston, TX (US); Amrik Sahota, Middlesex (GB); Evgeny Dyshlyuk, Middlesex (GB); Earle Cheshire, Middlesex (GB); Ian Thompson, Sunbury-on-Thames (GB)

(73) Assignee: BP Corporation North America Inc., Houston, TX (US)

(21) Appl. No.: 19/660,528

(22) Filed: Apr. 28, 2026

Related U.S. Application Data
(60) Provisional application No. 63/796,736, filed on Apr. 29, 2025.

(51) Int. Cl. G06F 21/57

(52) U.S. Cl. CPC G06F 21/577

(57) ABSTRACT

A computer-implemented method for forecasting future cyberthreats based on collected cyberthreat data includes collecting by a cyberthreat forecaster cyberthreat data including both unstructured data and structured data, extracting by the cyberthreat forecaster features from the cyberthreat data and storing the extracted features as transformed cyberthreat data, applying by the cyberthreat forecaster the transformed cyberthreat data to a cyberthreat predictive model of the cyberthreat forecaster, and providing to a user by the cyberthreat predictive model a forecast of future cyberattacks based on the transformed cyberthreat data.

### CROSS-REFERENCE TO RELATED APPLICATIONS

This application is a non-provisional application which claims benefit of U.S. provisional patent application No. 63/796,736 filed Apr. 29, 2025, and entitled “Systems and Methods for Cyberthreat Forecasting,” which is hereby incorporated herein by reference in its entirety for all purposes.

### STATEMENT REGARDING FEDERALLY SPONSORED RESEARCH OR DEVELOPMENT

Not applicable.

### BACKGROUND

Corporations and other organizations face a constantly evolving landscape of cyberthreats that can disrupt operations, compromise sensitive data, and inflict long-lasting reputational and financial damage. Generally, cyberthreats are any potential danger or malicious activity targeting computer systems, networks, or digital data that can lead to unauthorized access, disruption, or damage. As an example, cyberthreats include, among other things, malware, ransomware, and phishing attacks which exploit vulnerabilities in software and human behavior alike. As another example, cyberthreats include advanced persistent threats (APTs) that surreptitiously infiltrate systems over extended periods to exfiltrate valuable intellectual property. The stakes presented by cyberthreats may be high -a successful breach can lead not only to significant direct financial losses but also to legal liabilities, regulatory fines, and erosion of customer trust. Consequently, maintaining robust security protocols, investing in cutting-edge technology, and fostering a culture of continuous vigilance are critical for organizations to safeguard their assets and ensure sustainable operational resilience in today's digital era.

### BRIEF SUMMARY OF THE DISCLOSURE

An embodiment of a computer-implemented method for forecasting future cyberthreats based on collected cyberthreat data comprises (a) collecting by a cyberthreat forecaster cyberthreat data comprising both unstructured data and structured data, (b) extracting by the cyberthreat forecaster features from the cyberthreat data and storing the extracted features as transformed cyberthreat data, (c) applying by the cyberthreat forecaster the transformed cyberthreat data to a cyberthreat predictive model of the cyberthreat forecaster, and (d) providing to a user by the cyberthreat predictive model a forecast of future cyberattacks based on the transformed cyberthreat data. In some embodiments, the forecast of future cyberattacks comprises a total number of future cyberattacks across a user-selected time period. In some embodiments, the forecast of future cyberattacks comprises a total number of future cyberattacks across a user-selected time period and directed against a user-selected organization. In certain embodiments, the forecast of future cyberattacks comprises a total number of future cyberattacks across a user-selected time period and employing at least one of a user-selected tactic, a selected technique, and a selected procedure. In certain embodiments, the forecast of future cyberattacks comprises a total number of future cyberattacks across a user-selected time period and directed against a user-selected location. In some embodiments, the forecast of future cyberattacks comprises a total number of future cyberattacks across a user-selected time period and corresponding to a user-selected threat actor. In some embodiments, the forecast of future cyberattacks comprises a total number of future cyberattacks across a user-selected time period and targeting a user-selected vulnerability. In certain embodiments, the method includes (e) notifying the user of one or more defensive measures to address at least some of the forecasted future cyberattacks provided at (d). In certain embodiments, (b) comprises (b1) applying the unstructured data to a generative artificial intelligence (AI) model, and (b2) generating by the generative AI model the extracted features from the unstructured data. In some embodiments, (b) comprises (b1) applying the unstructured data to a retrieval augmented generation (RAG) model, (b2) providing by the RAG model the unstructured data to a generative artificial intelligence (AI) model, and (b3) generating by the generative AI model the extracted features from the unstructured data.

An embodiment of a computer-implemented method for forecasting future cyberthreats based on collected cyberthreat data comprises (a) collecting by a cyberthreat forecaster cyberthreat data comprising both internal data and external data with respect to an organization, (b) extracting by a cyberthreat forecaster features from the cyberthreat data and storing the extracted features as transformed cyberthreat data, (c) applying by a cyberthreat forecaster the transformed cyberthreat data to a cyberthreat predictive model of the cyberthreat forecaster, and (d) providing to a user by the cyberthreat predictive model a forecast of future cyberattacks directed against the organization and based on the transformed cyberthreat data. In some embodiments, the internal data comprises historical data associated with past incidents of the organization and organizational data. In certain embodiments, the cyberthreat data comprises at least one of technical cyberthreat data, tactical cyberthreat data, operational cyberthreat data, and strategic cyberthreat data. In certain embodiments, the external data comprises one or more cyberthreat reports. In some embodiments, the cyberthreat data comprises at least one of a tactic, a technique, and a procedure of a threat actor. In some embodiments, the method comprises (e) notifying the user of one or more defensive measures to address at least some of the forecasted future cyberattacks provided at (d).

An embodiment of a computer-readable medium storing executable code which, when executed by a processor, causes the processor to (a) collect cyberthreat data comprising both unstructured data and structured data, (b) extract features from the cyberthreat data and storing the extracted features as transformed cyberthreat data, (c) apply the transformed cyberthreat data to a cyberthreat predictive model, and (d) provide to a user by the cyberthreat predictive model a forecast of future cyberattacks based on the transformed cyberthreat data. In certain embodiments, the forecast of future cyberattacks comprises a total number of future cyberattacks across a user-selected time period. In certain embodiments, the forecast of future cyberattacks comprises a total number of future cyberattacks across a user-selected time period and directed against a user-selected organization. In some embodiments, the executable code, when executed by the processor, causes the processor to (e) notify the user of one or more defensive measures to address at least some of the forecasted future cyberattacks provided at (d).

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of exemplary embodiments of the disclosure, reference will now be made to the accompanying drawings in which:

FIG. 1 depicts a block diagram of a computer-implemented cyberthreat forecasting system according to some embodiments;

FIG. 2 is a diagram of a cyberthreat landscape according to some embodiments;

FIG. 3 is a diagram of extracting one or more selected features from unstructured cyberthreat data according to some embodiments;

FIG. 4 is a block diagram of a cyberthreat forecaster according to some embodiments;

FIG. 5 is visualization of a cyberthreat according to some embodiments;

FIG. 6 is a block diagram of another cyberthreat forecaster according to some embodiments;

FIG. 7 depicts a block diagram of a computer system according to some embodiments; and

FIGS. 8 and 9 depict flowchart of computer-implemented methods for forecasting future cyberthreats based on collected cyberthreat data according to some embodiments.

### DETAILED DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

As described above, cyberthreats are any potential danger or malicious activity targeting computer systems, networks, or digital data. Cyberthreats encompass a wide range of attack vectors including, but not limited to, zero-day exploits, APTs, ransomware, distributed denial of service (DDoS) attacks, and sophisticated phishing campaigns. Zero-day exploits take advantage of previously unknown vulnerabilities in software or hardware, often remaining undetected until significant damage is inflicted. APTs, in particular, involve adversaries establishing long-term footholds within a target network by leveraging custom malware, lateral movement techniques, and stealthy command-and-control channels to exfiltrate sensitive data or disrupt operations. Ransomware employs robust encryption algorithms to lock critical data, with attackers demanding payment for decryption keys, while DDoS attacks overwhelm network resources, rendering services unavailable through a flood of illegitimate traffic. Additionally, the use of malware-less attacks, often referred to as living off the land (LOTL), involves attackers using legitimate system tools like Microsoft PowerShell® and Windows Management Instrumentation (WMI) to facilitate attacks. This further complicates detection efforts by conducting malicious activity with the use of non-malicious system operation tools and techniques commonly used by legitimate system administrators.

The parties responsible for these cyberthreats are diverse and range broadly in their level of sophistication. Such parties are referred to herein as “threat actors” and include individuals or groups of individuals seeking to breach or otherwise undermine an organization's systems and data security. Threat actors may engage in direct data theft, phishing, compromising an organization's information technology (IT) via vulnerability exploitation, and/or the creation of malware. Generally, threat actors make cyberattacks against the technology estate of targeted organizations where the term “cyberattack” as used herein refers to incidents with malicious intent such as, for instance, a threat actor brute forcing the credentials of an organization's employee. Additionally, the term “technology estate” as used herein refers to the collection of all technology assets and resources used by the organization to support its operations and which includes both tangible and intangible assets like hardware, software, and data. Further, the term “incident” as used herein refers to an alert (e.g., something indicative of a problem with respect to an organization's technology estate) or combination of alerts which result in a security investigation. For example, incidents may include unauthorized access (e.g. account hijacking, data breaching), inappropriate usage (e.g., intrusion, vulnerability exploits, compromise, network mismanagement), denial of service (e.g., distributed denial of service, amplification cyberattacks), and malicious code (e.g., malicious software, malicious mobile applications, and malicious web applications). Tactics, techniques, and procedures (TTP) describe the behaviors, strategies, and methods used by threat actors in developing and executing cyberattacks on a targeted organization's technology estate.

Nation-state actors are among the most sophisticated threat actors, often operating with substantial resources and technical expertise to conduct cyber espionage, sabotage, or influence operations that align with strategic geopolitical objectives. Cybercriminal actors, driven primarily by financial incentives, utilize an arsenal of tactics ranging from ransomware and credit card fraud to data breaches and identity theft. Hactivists, motivated by ideological or political causes, leverage cyberattacks such as DDoS, website defacement, and information leaks to bring attention to their agendas or to protest policies and practices they oppose. Furthermore, insider threats—whether stemming from intentional malfeasance, negligence, or coercion—present a significant risk as these individuals possess legitimate access credentials, allowing them to bypass many external security controls.

In response, organizations often employ a layered defense strategy that integrates advanced threat detection, continuous monitoring, vulnerability management, and incident response mechanisms. For instance, organizations deploy firewalls, intrusion detection and prevention systems, antivirus software, and endpoint protection solutions to safeguard their networks and systems. They also implement advanced monitoring tools like Security Information and Event Management (SIEM) systems, which aggregate and analyze logs to detect anomalies that might indicate malicious activity. Additional strategies often employed by organizations in addressing cyberthreats include Endpoint Detection and Response (EDR) solutions and network Intrusion Detection Systems (IDS).

Particularly, EDR systems comprise advanced security tools that focus on monitoring and securing an organization's individual endpoints—such as desktops, laptops, servers, and mobile devices—against sophisticated cyberthreats. EDR platforms continuously collect and analyze data from endpoints to identify abnormal behavior or suspicious activities, employing techniques like behavioral analytics, machine learning, and forensic analysis. These tools not only detect potential indicators of compromise, such as unusual process executions, unexpected file modifications, or lateral movement within a network, but also provide automated and manual response capabilities. When a threat is detected, EDR systems may isolate the affected endpoint, terminate malicious processes, and gather detailed telemetry data to support incident investigations. This comprehensive visibility and rapid response help organizations contain breaches before they can escalate and spread across the broader network environment.

IDS, on the other hand, monitor and analyze an organization's network traffic for signs of malicious activities or policy violations. Deployed at critical points within a network—such as at gateways or near sensitive data repositories, IDS examine packet flows in real time using a variety of detection methodologies. These methods typically include signature-based detection, which compares traffic patterns against known cyberattack signatures, and anomaly-based detection, which identifies deviations from established baselines of normal network behavior. For example, by scrutinizing both the header and payload of network packets, IDS can identify a range of threats, from scanning and reconnaissance activities to full-blown network intrusions and data exfiltration attempts. While IDS provide critical insight into network-wide activities, they may face challenges such as encrypted traffic analysis and the potential for high false positive rates. To address these issues, organizations often integrate IDS with other security solutions like SIEM systems and endpoint monitoring tools like EDR, creating a layered defense strategy that correlates network data with endpoint insights for a more accurate and timely detection of security incidents.

Despite these measures, several shortcomings persist. For instance, many traditional security tools rely on signature-based detection, making them less effective against new or evolving threats such as zero-day vulnerabilities and sophisticated APTs. The complexity of modern IT environments can lead to misconfigurations and integration challenges, creating potential gaps in defense. Additionally, the high volume of alerts generated by monitoring systems can overwhelm security teams, leading to alert fatigue and delayed response times. Finally, human error remains a significant vulnerability, as employees may inadvertently bypass security protocols or fall victim to well-crafted social engineering cyberattacks, highlighting the need for continuous improvement in both technology and training.

In addition, EDR, IDS, and related strategies, while integral to modern cybersecurity, exhibit notable limitations, particularly in their capacity to predict future cyberthreats. Particularly, both EDR and IDS are constrained by the fundamental difficulty of predicting future cyberthreats. Their analytical models are tuned to historical incidents, which means they lack intrinsic predictive capabilities to foresee and mitigate emerging cyberattack vectors that have not yet manifested. This shortfall necessitates the integration of additional threat intelligence, proactive research, and advanced predictive analytics to better anticipate and counteract new and evolving cyberthreats. In summary, while EDR, IDS, and other current strategies for addressing cyberthreats provide valuable real-time detection and response capabilities against known and occurring cyberattacks, their inherent design limitations underscore the need for a broader, more proactive security strategy that extends beyond reactive measures based on past events.

Accordingly, embodiments of cyberthreat forecasters and related systems and methods are disclosed herein that provide a user thereof a forecast of future cyberattacks based on collected cyberthreat data. For instance, the forecast of future cyberattacks may include a total number of future cyberattacks across a user-selected time period. Additionally, the forecast of future cyberattacks may include a total number of future cyberattacks across a user-selected time period and directed against a user-selected organization's assets, or those that employ a user-selected tactic, a selected technique, and a selected procedure.

Embodiments of cyberthreat forecasters may include a cyberthreat predictive model for forecasting future cyberthreats such as future cyberattacks based on collected cyberthreat data (including organization specific data) and one or more filters applied by a user thereof. The cyberthreat predictive model may comprise a machine learning (ML) model trained using previously collected cyberthreat (again including organization specific data) data and activity. In this manner, the cyberthreat forecaster may objectively and automatically forecast future cyberattacks to provide critical insight to stakeholders of an associated organization. Additionally, embodiments of cyberthreat forecasters may also provide suggested defensive measures and other guidance to the user for addressing these forecasted cyberthreats in view of existing vulnerabilities and other parameters.

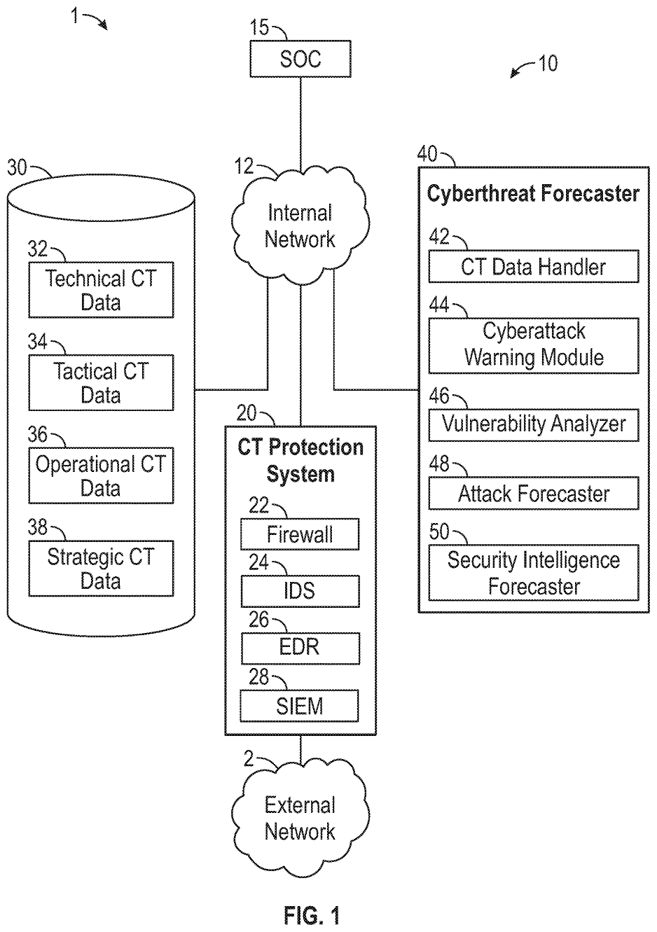

Referring initially to FIG. 1, an embodiment of a computer-implemented cyberthreat forecasting system 10 is shown. As will be further explained herein, system 10 generally includes an internal network 12 owned and/or operated by an organization 1, a security operations center (SOC) 15, a cyberthreat protection system 20 connected to an external network 2 (e.g., the internet), a cyberthreat data repository or structure 30, and a cyberthreat forecaster 40. The organization or structure of SOC 15, cyberthreat protection system 20, cyberthreat data structure 30, and cyberthreat forecaster 40 shown in FIG. 1 is only exemplary and provided for the sake of explaining the various features and functionalities thereof. The structure of system 10 may thus vary substantially from that shown in FIG. 1 in other embodiments.

SOC 15 is connected to internal network 12 and is generally responsible for protecting the organization 1 operating internal network 12 against cyberthreats and may include a centralized response team addressing security issues within the organization 1. Personnel of SOC 15 may interface or operate various tools of system 10 including, for example, cyberthreat protection system 20, cyberthreat data structure 30, and cyberthreat forecaster 40.

Cyberthreat protection system 20 of system 10 is connected to internal network 12 and includes one or more tools for addressing cyberthreat threats to the organization 1. In this exemplary embodiment, cyberthreat protection system 20 generally includes a firewall 22, an intrusion detection system (IDS) 24, an EDR system 26, and a SIEM 28. Firewall 22 of cyberthreat protection system 20 monitors and controls incoming and outgoing network traffic (e.g., between external network 2 and internal network 12) based on predefined security rules to mitigate the possibility of unauthorized access and cyberthreats.

IDS 24 of cyberthreat protection system 20 monitors internal network 12 for malicious activity and/or policy violations and may be placed at strategic points within the flow of traffic across internal network 12 whereby IDS 24 may monitor traffic to and from all devices on the internal network 12. For instance, IDS 24 may analyze passing traffic on an entire subnet of internal network 12 and match the traffic to a library of known cyberattacks (e.g., stored in cyberthreat data structure 30). Upon identifying abnormal behavior, IDS 24 may provide an alert to personnel of SOC 15. Consistent with the above, EDR system 26 of cyberthreat protection system 20 monitors the various network endpoints (e.g., smartphones, laptops, Internet-of-Things (IoT) devices) of the organization 1 such as the endpoints of internal network 12. EDR system 26 may continuously collect and analyze cyberthreat data from the endpoints of internal network 12 to identify anomalous behavior that could be associated with cyberthreats. Also consistent with the above, SIEM 28 of cyberthreat protection system 20 may comprise a core component of SOC 15 that aggregates and analyzes across the technology estate of organization 1 including internal network 12.

Cyberthreat data structure 30 of system 10 is connected to internal network 12 and ingests and/or stores various types of cyberthreat data (including organization specific data), employed by cyberthreat forecaster 40 in managing and/or forecasting cyberattacks or other network security issues. In this exemplary embodiment, cyberthreat (indicated as “CT” in the figures) data structure 30 generally includes technical cyberthreat data 32, tactical cyberthreat data 34, operational cyberthreat data 36, and/or strategic cyberthreat data 38. The various different types of cyberthreat data captured in cyberthreat data structure 30 includes both external cyberthreat data that is procured from sources external outside organization 1 such as newsfeeds, cyber intelligence (CI) reports and the like, and internal cyberthreat data that originates within the organization 1 such as data captured by cyberthreat protection system 20, internal incident reports, organizational asset database, organizational activity, organizational vulnerability data and the like. As will be discussed further herein, the various types of cyberthreat data captured by cyberthreat data structure 30 is leveraged by cyberthreat forecaster 40 in monitoring and/or forecasting cyberattacks and/or other cyberthreats.

Generally, technical cyberthreat data includes the collection of indicators of compromise (IoC) which refers to the artifacts of potential intrusions on an organization's technology estate. Such artifacts include malicious artifacts such as malicious IP addresses, uniform resource locators (URLs), malware hashes and file names. Technical cyberthreat data may be provided to investigative and monitoring tools of the organization.

Tactical cyberthreat data 34 includes TTPs consistent with the above description of such. Particularly, TTPs are described in the content of reports and refer to the description of a cyberthreat including the threat actor's actions and behaviors observed during a cyber-attack. Tactical cyberthreat data 34 may be used to improve defense strategies for current tactics.

Operational cyberthreat data 36 includes information about specific impending cyberattacks against a targeted organization's technology estate. Operational cyberthreat data 36 may describe relevant factors of a specific cyberattack such as, for instance, the nature, timing, and intent of threat actors involved in the cyberattack. Operational cyberthreat data 36 may be utilized by personnel of the SOC 15. Finally, strategic cyberthreat data 38 includes high level information in the form of the motivations detailed in documents such as cyberthreat reports, briefings, conversations, and the like, that help security decision-makers understand and identify current and future cyberthreat risks. This information includes, among other things, financial impacts, trends, and historical data on cyberattacks.

The different cyberthreat data 32, 34, 36, and 38 is captured differently and at different timescales. For instance, technical cyberthreat data 32 is often collected automatically in real-time or near real-time (e.g., minutes, hours). Tactical cyberthreat data 32 may be collected or generated manually such as by personnel of SOC 15 and at a relatively longer timescale of near real-time or longer (e.g., days, weeks). Operational cyberthreat data 36 is often collected or generated manually by external sources such as cyber defense professionals (e.g., on the timescale of days, weeks, or months) to assist with planning for cyberthreats in the longer-term. Finally, strategic cyberthreat data 38 may be collected at the longest timescale (e.g., months to years) and is often intended for leadership of the organization 1.

In addition, the different cyberthreat data 32, 34, 36, and 38 is captured differently and at different timescales may be both structured and unstructured in format. Particularly, technical cyberthreat data 32, which is generally collected automatically by software tools, is often in a structured format where tactical cyberthreat data 34, and operational and strategic cyberthreat data 36 and 38, is often in an unstructured format. Unstructured data generally requires the extraction of structured data therefrom to facilitate automated cyberthreat forecasting and the like, as will be discussed further herein.

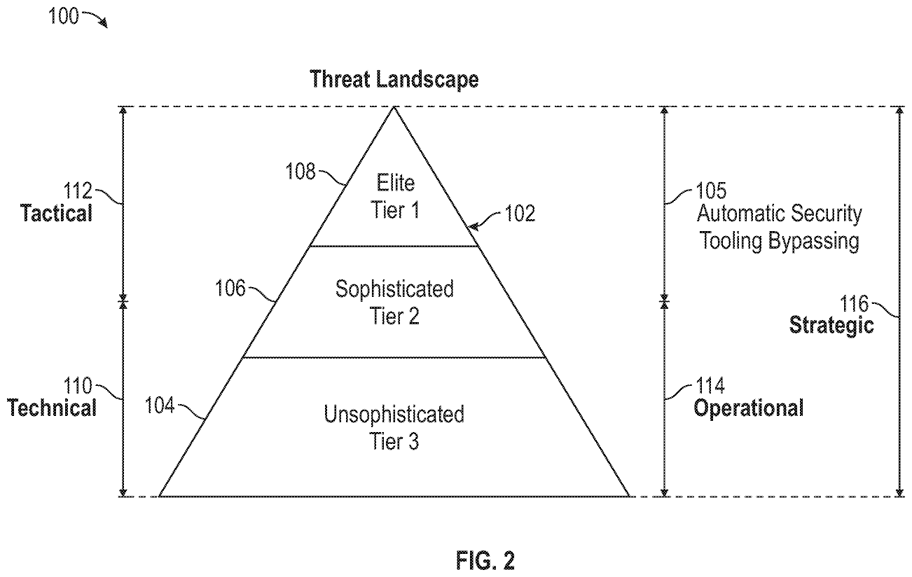

Referring to FIG. 2, a diagram 100 is shown illustrating an exemplary cyberthreat landscape 102 to further facilitate understanding of the different types of cyberthreat data employed by system 10 in automatically forecasting cyberthreats. In the example provided by diagram 100, cyberthreat landscape 102 is pyramidal in shape with unsophisticated (Tier 3) threat actors 104 occupying the base thereof, sophisticated (Tier 2) threat actors 106 occupying an intermediate layer thereof, and elite (Tier 1) threat actors 108 occupying the top thereof. Diagram 100 also illustrates the four types of intelligence (Technical, Tactical, Operational and Strategic). Dimensions 110, 112, 114, and 116 map these intelligence types onto the cyberthreat landscape 102. While the different intelligence types can cover all levels of threat landscape, the arrows 110, 112, 114 and 116 indicate where the four types of intelligence that may hold the most value in relation to defending against the different sophistication levels. As indicated by arrow 105 in diagram 100, the most sophisticated threat actors including elite threat actors 108 and the sophisticated threat actors 106 can bypass automatic security tooling such as, for example, elements of the cyberthreat protection system 20 shown in FIG. 1.

Particularly, the technical cyberthreat data dimension 110 is most valuable in defending against unsophisticated threat actors 104 and some sophisticated threat actors 106 but is generally not associated with elite threat actors 108. For instance, given that unsophisticated threat actors 104 are typically unable to bypass automatic security tooling, such cyberthreat data tends to be unrelated or unhelpful with respect to the activities of more sophisticated threat actors such as elite threat actors 108. Additionally, operational cyberthreat data dimension 114 is also associated with unsophisticated threat actors 104 and the lower tier of sophisticated threat actors 106. Particularly, there are typically more unsophisticated threat actors 104 than elite threat actors 108 (explaining the pyramidal shape of cyberthreat landscape 102) and thus unsophisticated threat actors 104 provide relatively more data in the tactical and operational realm for gaining insight into unprotected cyberattack surfaces and the like of an organization's technology estate.

Conversely, the tactical cyberthreat data dimension 112 provides the most value in terms of defending against the elite threat actors 108 and the upper tier of sophisticated threat actors 106. Such cyberthreat data is useful for understanding the TTPs of such sophisticated threat actors who generally can bypass automatic security tooling. Finally, the strategic cyberthreat data dimensions 116 is associated with the entire cyberthreat landscape 102 including each type of threat actor 104, 106, and 108. Thus, the activities of each type of threat actor 104, 106, and 108 is relevant for the collection of strategic cyberthreat data and/or strategic cyberthreat data is relevant for understanding and/or predicting cyberattacks made by each type of threat actor 104, 106, and 108.

Returning to FIG. 1, the tactical cyberthreat data 34 collected by cyberthreat data structure 30 covers all categories from unsophisticated, sophisticated and elite level threats including, for example, level one or surface level tactical cyberthreat data, and level two or deep level tactical cyberthreat data. Level one data is broad in scope and encompasses undifferentiated cyber activities where tracking generalized trends is more feasible. Thus, level one tactical cyberthreat data is characterized by a high volume of activity generally associated with less sophisticated threat actors who are more easily detected and monitored. Such activities are typically opportunistic, and the opportunistic nature of these activities often make them challenging to accurately forecast particularly with respect to their timing and location. However, level one tactical cyberthreat data may be employed by cyberthreat forecaster 40 to provide a view of overall cyber activity which may be compared to relatively more discreet, higher priority cyberthreat data.

Level two tactical cyberthreat data pertains to relatively more specialized and prioritized cyber activities and thus corresponds to a lower volume or frequency of incidents due to the lower tempo of such activities and increased operational security (OPSEC) thereof. Additionally, the cyber activities associated with level two tactical cyberthreat data is generally less opportunistic, more sophisticated and more targeted towards specific technology estate and data. Such cyber activities can include the acquisition of targeted intellectual property and other valuable proprietary and secret information. The potential value and predictability of these cyber activities are greater than the cyber activities associated with level one tactical cyberthreat data. Particularly, the advanced capabilities employed to bypass standard security measures (e.g., measures of cyberthreat protection system 20) and the targeted motivations involved enhance the predictability and value of forecasting such cyberattacks.

In this exemplary embodiment, cyberthreat forecaster 40 generally includes a cyberthreat data handler 42, a cyberattack warning module 44, a vulnerability analyzer 46, a cyberattack forecaster 48, and a security intelligence forecaster 50. As described above, at least some of the cyberthreat data utilized by cyberthreat forecaster 40 and stored in cyberthreat data structure 30 comprises unstructured data. Cyberthreat data handler 42 may transform such unstructured data into structured data usable by the cyberattack warning module 44, vulnerability analyzer 46, cyberattack forecaster 48, and security intelligence forecaster 50 of cyberthreat forecaster 40. For instance, cyberthreat data handler 42 may extract one or more selected features from unstructured data stored in cyberthreat data structure 30, the one or more extracted features usable by the cyberattack warning module 44, vulnerability analyzer 46, cyberattack forecaster 48, and security intelligence forecaster 50 to assist in facilitating their various functionalities as will be discussed further herein.

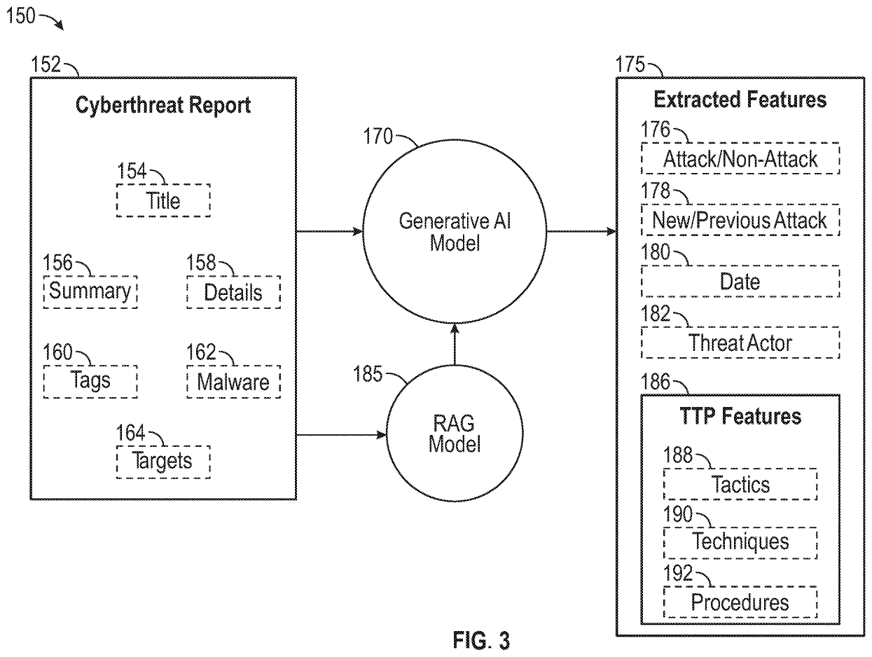

As an example, and referring to FIG. 3, a diagram 150 is shown of extracting one or more selected features from unstructured cyberthreat data using cyberthreat data handler 42. Diagram 150 illustrates one example of how cyberthreat data handler 42 may operate, and cyberthreat data handler 42 may perform differently and/or have additional functionalities than that presented in diagram 150. In this example, the unstructured cyberthreat data comprises a cyberthreat report 152 that may be prepared internally by personnel of the organization (e.g., organization 1) or externally by a cybersecurity firm. The cyberthreat report 152 generally comprises a qualitative report documenting the observed activity (e.g., previously committed cyberattacks and other malicious activity) of threat actors. Additionally, cyberthreat report 152 may be a valuable resource of levels one, two and/or tactical cyberthreat data 34 once cyberthreat report 152 has been transformed into usable structured data.

Cyberthreat report 152 includes commentary on these observed activities and may, for example, be organized as shown in FIG. 3 including a title 154, a summary or abstract 156, report details 158 (e.g., a body of the report), tags 160, malware 162 associated with the observed activity of the threat actor, and/or one or more targets 164 (e.g., targeted organizations or location) associated with the observed activity of the threat actor. Much or all the information contained in the cyberthreat report 152, including particularly the details 158 thereof, comprises unstructured data that must first be transformed into structured data by, for instance, cyberthreat data handler 42 before being utilized by cyberattack warning module 44 and/or security intelligence forecaster 50.

In this exemplary embodiment, cyberthreat data handler 42 utilizes a generative AI model 170 to transform the unstructured data contained in the cyberthreat report 152 into structured data in the form, for example, of a set of labels or extracted features 175. Generative AI model 170 may be internal to the organization 1 (e.g., part of the internal network 12) or external of the organization 1 and provided by a third party. In this exemplary embodiment, extracted features 175 include an attack/non-attack label 176, a new/previous cyberattack label 178, a date label 180, and a threat actor label 182. Particularly, attack/non-attack label 176 identifies whether the cyberthreat report 152 corresponds to a cyberattack or to some other activity by a threat actor. The new/previous attack label 178 classifies the cyberthreat report 152 as pertaining to a newly documented cyberattack or as providing further information pertaining to a previously documented cyberattack. Date label 180 classifies the date of the activity documented in the cyberthreat report 152. Finally, the threat actor label 182 identifies the one or more threat actors associated with the activity documented in the cyberthreat report 152.

Cyberthreat data handler 42 may also utilize a retrieval augmented generation (RAG) model 185 for extracting additional structured data from the generally unstructured data contained in the cyberthreat report 152. For instance, in this exemplary embodiment, RAG model 185 may ingest information from the cyberthreat report 152, provide the ingested data (e.g., along with one or more prompts such as zero-shot prompts) to the generative AI model 170 which may, in-turn, generate one or more TTP features 18 of the cyberthreat report 152 as structured data usable by the cyberattack warning module 44, vulnerability analyzer 46, cyberattack forecaster 48, and security intelligence forecaster 50. The TTP features 186 included in extracted features 175 may include one or more tactics 188, techniques 190, and/or procedure 192 associated with the cyberthreat report 152. For instance, the tactics 188, techniques 190, and procedures 192 of TTP features 186 may each be selected from a predefined list or library of TTP tactics, techniques, and procedures to thereby characterize these parameters. Further, in some embodiments, the extracted features 175 may be stored in a cyberthreat data structure such as the cyber threat data structure 30 shown in FIG. 1.

Referring again to FIG. 1, as described above, cyberthreat forecaster 40 includes cyberattack warning module 44, vulnerability analyzer 46, cyberattack forecaster 48, and security intelligence forecaster 50-each of utilizing the cyberthreat data contained in cyberthreat data structure 30 for implementing their various functionalities. Particularly, cyberattack warning module 44 of cyberthreat forecaster 40 provides early warning of a specific future cyberattack by one or more threat actors using historical and/or currently obtained cyberthreat data. In other words, cyberattack warning module 44 may provide the organization 1 an early warning of a future cyberattack based on prior and/or ongoing activities of one or more threat actors. In some embodiments, cyberattack warning module 44 utilizes structured data including technical cyberthreat data 32 such as port scanning activity and the like. In certain embodiments, cyberattack warning module 44 utilizes unstructured data such as technical cyberthreat data 32 including, for example, dark-web communications monitoring.

Vulnerability analyzer 46 of cyberthreat forecaster 40 analyzes and identifies existing vulnerabilities of the technology estate of organization 1 including, for example, internal network 12. The vulnerabilities identified by vulnerability analyzer 46 may be viewed by an end-user of cyberthreat forecaster 40 such as personnel of SOC 15 and/or may be used by other features of cyberthreat forecaster 40 such as cyberattack forecaster 48 and/or security intelligence forecaster 50. In certain embodiments, vulnerability analyzer 46 utilizes structured data including technical cyberthreat data 32 such as known (e.g., common) vulnerabilities and exposures. In some embodiments, vulnerability analyzer 46 utilizes unstructured data such as technical cyberthreat data 32 including, for example, internal intelligence on potential attacker targets.

Cyberattack forecaster 48 of cyberthreat forecaster 40 forecasts future cyberattacks by one or more threat actors based on information captured in cyberthreat data structure 30. The information used by cyberattack forecaster 48 may include, among other things, technical cyberthreat data 32, tactical cyberthreat data 34, operational cyberthreat data 36, and/or strategic cyberthreat data 38. In certain embodiments, the cyberattack forecast provided by cyberattack forecaster 48 is also based on information provided by cyberattack warning module 44 and/or vulnerability analyzer 46. For instance, information consistent with an impending cyberattack identified by cyberattack warning module 44 may increase the future probability of said cyberattack as forecasted by cyberattack forecaster 48. Additionally, the presence of an existing vulnerability identified by vulnerability analyzer 46 (particularly if said vulnerability is known by threat actors) may also increase the future probability of said cyberattack as forecasted by cyberattack forecaster 48

The cyberattack forecast provided by cyberattack forecaster 48 may be based on cyberthreat data in the form of historical data including structured data such as historical data on events, alerts, and incidents, and/or unstructured data such as historical cyberthreat reports (e.g., cyberthreat report 152 shown in FIG. 3). In certain embodiments, cyberattack forecaster 48 provides characterizing information related to a forecasted cyberattack such as identities of the threat actor(s) and target(s) of the cyberattack, timing of the cyberattack, location of the cyberattack, motive of the cyberattack, and/or information regarding how the cyberattack (e.g., techniques and/or procedures) will be conducted.

Security intelligence forecaster 50 of cyberthreat forecaster 40 provides insights or guidance on how organization 1 may defend its technology estate from future cyberattacks and other malicious activities conducted by threat actors including future cyberattacks forecasted by the cyberattack forecaster 48 of cyberthreat forecaster 40. In this manner, security intelligence forecaster 50 may integrate information provided by cyberattack forecaster 48 providing insight on the likelihood of different future cyberattacks with other information such as vulnerability information provided by vulnerability analyzer 46 to identify the presence of existing vulnerabilities that are likely to be exploited in the future based on the forecasted cyberattacks provided by cyberattack forecaster 48.

In some embodiments, cyberattack forecaster 48 forecasts the total number of global future cyberattacks over a selected time period (e.g., hours, days, weeks, months, and the like). The number of future cyberattacks forecasted by cyberattack forecaster 48 may be refined by target country, target industry, threat actor identity, TTPs, and other parameters. In such embodiments, security intelligence forecaster 50 may be leveraged to prioritize security actions in protecting the technology estate of organization 1 based on the threat actors, TTPs, and other user-selected parameters of the cyberattack forecast provided by cyberattack forecaster 48.

In certain embodiments, a user of cyberthreat forecaster 40 may refine the cyberattack forecast provided by cyberattack forecaster 48 by the location of a given facility and/or other element of the organization 1. In other words, cyberattack forecaster 48 may provide intra-organizational targeting information of forecasted cyberattacks. Additionally, in such embodiments, security intelligence forecaster 50 may provide preventative and/or mitigative measures for addressing these forecasted cyberattacks on a tactical level and which may be prioritized based on the TTP information and identity of threat actors included in the cyberattack forecast. In some embodiments, security intelligence forecaster 50 forecasts how the security of the technology estate of organization 1 developers in the longer-term strategic level (e.g., months, years).

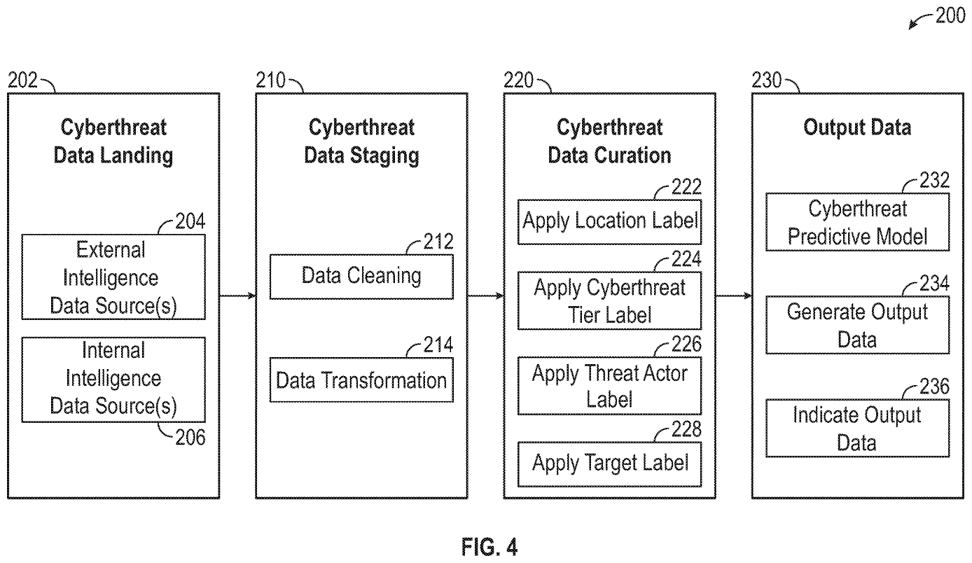

Referring to FIGS. 1 and 4, another embodiment of a cyberthreat forecaster 200 is shown that may be incorporated into or implemented by an organization's technology estate. For instance, in some embodiments, the cyberthreat forecaster 40 shown in FIG. 1 may implement at least some of the features of cyberthreat forecaster 200. Alternatively, the cyberthreat forecaster 40 shown in FIG. 1 may be configured differently from cyberthreat forecaster 200. Thus, in at least some embodiments, cyberthreat forecaster 40 implements or executes the various functions illustrated FIG. 4 as part of its operation.

In this exemplary embodiment, cyberthreat forecaster 200 generally includes a cyberthreat data landing layer 202, a cyberthreat data staging layer 210, a cyberthreat data curation layer 220, and an output data layer 230. Cyberthreat data is initially ingested (e.g., by the cyberthreat forecaster 40 or internal network 12 itself) at the cyberthreat data landing layer 202, where cyberthreat data landing layer 202 includes both external (e.g., originating external organization 1) cyberthreat data sources 204 and internal (e.g., originating internal organization 1) cyberthreat data sources 206. Both the external and internal cyberthreat data sources 204 and 206 may include unstructured data, structured data, technical cyberthreat data 32, tactical cyberthreat data 34, operational cyberthreat data 36, and/or strategic cyberthreat data 38.

In some embodiments, external cyberthreat data source 204 includes cyberthreat reports (e.g., cyberthreat report 152 shown in FIG. 3) prepared by third parties (external organization 1) such as cyber security firms (e.g., CrowdStrike, Dragos) and the like. Such cyberthreat reports may be an excellent source for cyberthreat data pertaining to elite threat actors (e.g., elite threat actors 108 shown in FIG. 2). In addition, external cyberthreat data sources 204 may include feed aggregators such as open-source web feed aggregators (e.g., Feedly) comprised of articles and/or other publications containing cyberthreat data. For instance, the feed aggregator may comprise a Really Simple Syndication (RSS) feed of articles containing cyberthreat data. In some embodiments, the web feed may be refined to focus on selected themes such as TTPs, key threat activities, threat actors, vulnerability insights, and other parameters. Such web feeds may provide a large volume of cyberthreat data that may be useful in establishing trends and in determining the what, when, and how of forecasted cyberattacks. However, such web feeds may be subject to duplication and/or other issues that may need to be addressed by cyberthreat forecaster 200 as will be discussed further herein.

External cyberthreat data sources 204 may also include intelligence collected from communications from threat actors such as content obtained from dark-web forums, chats, and other communication platforms. Such threat actor intelligence may be obtained directly from dark-web sources and the like, or via cyberthreat reports (e.g., Intel 471) that comment and report on observed claims made by threat actors such as claimed data breaches and other successful cyberattacks. External cyberthreat data sources 204 may further include accessible cyberthreat databases (e.g., MITRE ATT&CK) including, for example, TTP databases containing known tactics, techniques, and procedures of existing threat actors.

In certain embodiments, the internal cyberthreat data sources 206 of cyberthreat forecaster 200 includes historical data collected over time by the organization 1. For example, the historical data may comprise structured data in the form of previous events, alerts, and incidents. The historical data may also comprise unstructured data such as internally prepared cyberthreat reports on previous incidents, known TTPs of threat actors, and the like. Thus, the historical data captured by internal cyberthreat data sources 206 may provide information on prior incidents within the specific organization 1. Further, although internal cyberthreat data sources 206 are shown as ingested at the cyberthreat data landing layer 202 of cyberthreat forecaster 200, in other embodiments, internal cyberthreat data sources 206 may instead be ingested at the cyberthreat data curation layer 220 thereof.

In this exemplary embodiment, the cyberthreat data staging layer 210 of cyberthreat forecaster 200 generally includes data cleaning 212 and data transformation 214. Data cleaning 212 of cyberthreat data staging layer 210 may clean the cyberthreat data (e.g., external and/or internal cyberthreat data) initially ingested at the cyberthreat data landing layer 202. For example, data cleaning 212 may include removing duplicative cyberthreat data based on one or more parameters such as an identification (ID) and/or date information (e.g., a last-modified date). In another example, data cleaning 212 may include removing extraneous information from the ingested cyberthreat data such as control characters, hypertext markup language (HTML), and the like. Additionally, data transformation 214 may transform at least some of the cleaned cyberthreat data from unstructured data to structured data. In certain embodiments, data transformation 214 implements the features of diagram 150 (e.g., generative AI model 170, RAG model 185) shown in FIG. 3.

Generally, the cyberthreat data curation layer 220 of cyberthreat forecaster 200 further cleans and organizes the cleaned cyberthreat data received from cyberthreat data staging layer 210. Particularly, the cyberthreat data curation layer 220 may organize the cleaned cyberthreat data into multiple separate or discrete domains as will be discussed further herein. In this exemplary embodiment, cyberthreat data curation layer 220 generally includes applying location labels 222, applying cyberthreat tier labels 224, applying threat actor labels 226, and applying target labels 228 In some embodiments, applying location labels 222 includes applying standardized location labels (e.g., selected from a predefined location library or dictionary) based on location information included in the cleaned cyberthreat data but which may vary from the standardized location labels. For instance, the location information may specify a country associated with the given cleaned cyberthreat data and applying the location label 222 in this instance may refer to applying a region location label that corresponds to the given country location information.

In certain embodiments, applying cyberthreat tier labels 224 includes applying standardized cyberthreat tier labels (e.g., selected from a predefined threat tier library) based on information included in the cleaned cyberthreat data. In some embodiments, the standardized threat tiers may correspond to threat tiers identified in cyberthreat landscape 102 in FIG. 2. Alternatively, the standardized cyberthreat tiers may vary from that shown in FIG. 2. In certain embodiments, the cyberthreat tier label for a given cleaned cyberthreat data may be inferred or cross-referenced from other information contained therein, such as the identification of threat actors associated with the cyberthreat data. In some embodiments, applying threat actor labels 224 includes applying standardized threat actor labels (e.g., selected from a predefined threat actor library) based on information included in the cleaned cyberthreat data. For instance, cyberthreat data may include information identifying threat actors in unstructured form, whereas applying threat actor labels 226 may include identifying the threat actors using information in structured form.

In certain embodiments, applying target labels 228 includes applying standardized cyberthreat target labels (e.g., selected from a predefined target library) based on information included in the cleaned cyberthreat data. Such target labels may be obtained from unstructured data from which target labels 228 may be determined or inferred (e.g., text included in the summary 156 of the cyberthreat report 152 shown in FIG. 3). The cyberthreat target labels may identify industries, organizations, and/or intra-organizational features such as selected facilities, systems, and the like for a given organization. Although not shown in FIG. 4, additional labels may also be applied to the cleaned cyberthreat data at the cyberthreat data curation layer 220. For instance, TTP labels (e.g., tactic labels, technique labels, and/or procedure labels) may be applied from a predefined TTP library, malware or tooling labels may be applied from a predefined malware/tooling library, and/or vulnerability labels may be applied from a predefined vulnerability library.

In this exemplary embodiment, the output data layer 230 of cyberthreat forecaster 200 generally includes a multi-domain (e.g., multi-data domain) cyberthreat predictive model 232 from which different kinds of output data may be generated 234 and indicated 236 to an end-user. In some embodiments, cyberthreat predictive model 232 comprises a trained machine learning (ML) predictive model that has been trained on previously obtained training data in the form of cyberthreat data. For instance, cyberthreat predictive model 232 may be trained using the labeled cyberthreat data provided by cyberthreat data curation layer 220. Thus, the training data may be like the actual input data provided to the cyberthreat predictive model 232 (following training) for generating output data therefrom. In certain embodiments, cyberthreat predictive model 232 comprises a deep learning (DL) model based on, for example, one or more neural networks (NNs).

The output data generated 234 by cyberthreat predictive model 232 may comprise information provided by the cyberattack forecaster 48 shown in FIG. 1, and/or information provided by security intelligence forecaster 50 also shown in FIG. 1. For instance, the output data may comprise a cyberattack forecast including a global number of forecasted cyberattacks over a user-defined time period. The cyberattack forecast provided by cyberthreat predictive model 232 may be refined by one or more parameters including threat actor, cyberthreat tier, location, threat target, TTPs, malware/tooling, and the like. Additionally, the output data generated 234 by cyberthreat predictive model 232 may be indicated or otherwise provided to the end-user at output data layer 230. For instance, the output data may be visualized as a heatmap broken down by different regions over a user-selected time period. Alternatively, the output data may be indicated 236 as a graph, chart, or other structure for visualizing the output data.

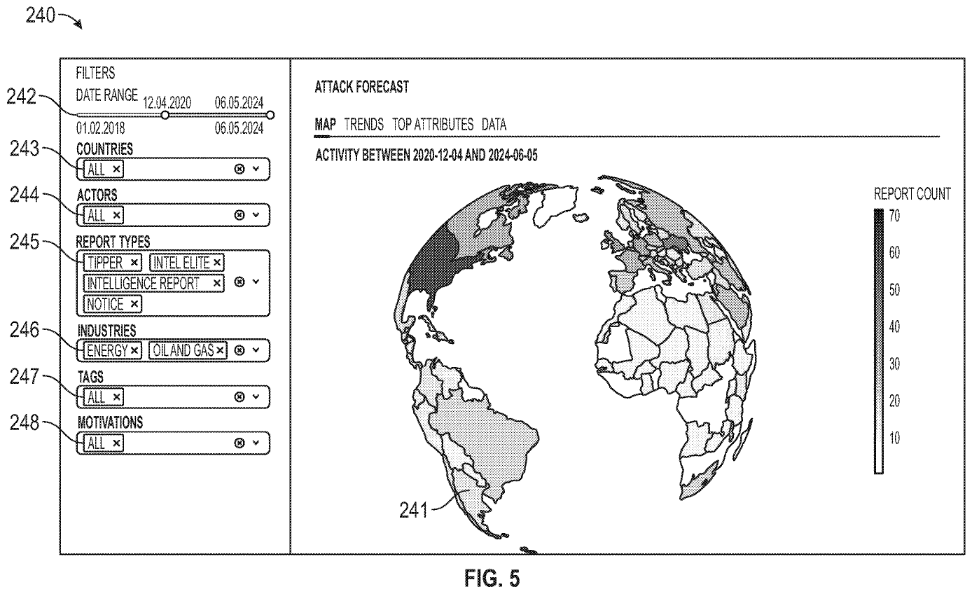

Referring to FIG. 5, an exemplary cyberthreat visualization 240 is provided as an example of a visualization of the output data generated by cyberthreat predictive model 232 of FIG. 4. In this exemplary embodiment, cyberthreat visualization 240 comprises a cyberattack forecast of future cyberattacks predicted by, for instance, cyberthreat predictive model 232. The cyberattack forecast is presented in the form of a globe broken down country-by-country with the number of forecasted cyberattacks per country displayed as a heatmap. Additionally, the cyberattack forecast of cyberthreat visualization 240 includes a plurality of user-selectable filters including, for example, a selected date range 242, a country filter 243, a threat actor filter 244, a cyberthreat data type filter 245, an industry filter 246, a tag filter 247, and a TTP or motivations filter 248. Particularly, cyberthreat data type filter 245 may permit an end-user to select cyberthreat data types or formats (e.g., cyberthreat reports, web feeds) from which the cyberattack forecast is based. In addition, the tag filter 247 may filter the cyberattack forecast based on one or more tags included in the cyberthreat data from which the cyberattack forecast is provided by the cyberthreat predictive model. Further, the motivations filter 248 may filter the cyberattack forecast by selected motivations or tactics. Additional filters may also be provided to the cyberattack forecast not shown in FIG. 5, which is only one example of how the output data generated by a cyberthreat predictive model may be visualized for the benefit of an end-user thereof.

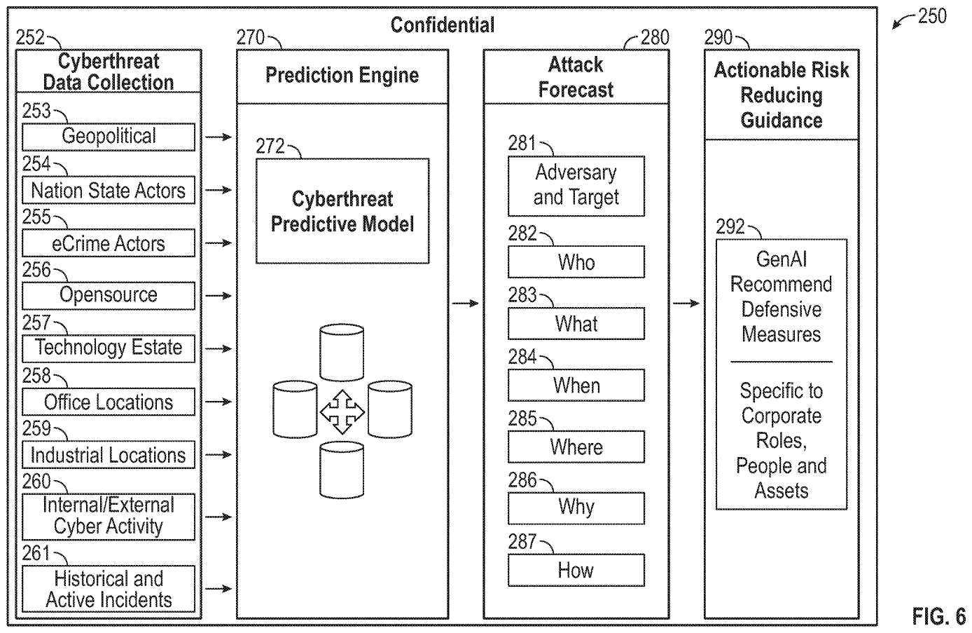

Referring to FIG. 6, another embodiment of a cyberthreat forecaster 250 is shown that may be incorporated into or implemented by an organization's technology estate. For instance, in some embodiments, the cyberthreat forecaster 40 shown in FIG. 1 may implement at least some of the features of cyberthreat forecaster 250. Alternatively, the cyberthreat forecaster 40 shown in FIG. 1 may be configured differently from cyberthreat forecaster 250. In this exemplary embodiment, cyberthreat forecaster 250 generally includes a cyberthreat data collection layer 252, a prediction engine layer 270, a cyberattack forecast layer 280, and an actionable guidance layer 290.

In this exemplary embodiment, the cyberthreat data collection layer 252 of cyberthreat forecaster 250 includes cyberthreat data collected various data sources including, for example, geopolitical data 253, nation state actor data 254, electronic-crime (eCrime) actor data 255, opensource data 256, technology estate data 257, office location data 258, industrial location data 259, internal/external cyber activity data 260, and historical/active incidents data 261. Some of these sources of cyberthreat data are outward looking and focus on potential threats such as, for instance, geopolitical data 253, nation state actor data 254, eCrime actor data 255, and opensource data 256. Conversely, some of these sources of cyberthreat data are inwards looking and focus on the organization protected by cyberthreat forecaster 250 such as, for instance, technology estate data 257, office location data 258, industrial location data 259, internal/external cyber activity data 260. Other inward looking data includes the location of different industrial assets (industrial location data 259) and of different offices (office location data 258) of the organization that may contain sensitive information and/or other resources of the technology estate of the organization.

In this exemplary embodiment, the prediction engine layer 270 of cyberthreat forecaster 250 generally includes a cyberthreat predictive model 272 that uses the cyberthreat data collected at cyberthreat data collection layer 252 to generate output data forming the cyberattack forecast layer 280. In some embodiments, cyberthreat predictive model 272 is configured similarly as the cyberthreat predictive model 232 shown in FIG. 4. Alternatively, the cyberthreat predictive model 272 may be configured differently than the cyberthreat predictive model 232 shown in FIG. 4. Additionally, in some embodiments, cyberthreat predictive model 272 comprises a trained ML model such as a DL model and the like. For instance, in certain embodiments, cyberthreat predictive model 272 may be trained using training data comprising previously collected cyberthreat data obtained from cyberthreat data collection layer 252. In some embodiments, the cyberthreat data upon which the cyberthreat predictive model 272 is trained and/or uses as input data in generating cyberattack forecasts may be mapped to specific organization scenarios. In this exemplary embodiment, the organization scenarios may include a combination of activities such as known business operational focuses mapped to regional locations and further linked to knowledge of key technologies upon which those operations depend. Additionally, these scenarios may incorporate insights from prior and ongoing security investigations and monitoring regarding vulnerabilities and/or security gaps. The multitude of organization scenarios may be globally mapped to threat trends, patterns, and threat predictions. This mapping is intended to highlight the key mitigation strategies required to proactively defend against predictable threat scenarios, thereby safeguarding the organization's operations before attacks are detected. Cyberattack forecast layer 280 may provide a cyberattack forecast that estimates the likelihood of future cyberattacks over a selected time period and/or other filters. Additionally, cyberattack forecast layer 280 provides a set of contextualizing information regarding the cyberattack forecast to give the end-user of cyberthreat forecaster 250 useful and actionable information in addition to a prediction of the number of future cyberattacks. Particularly, in this exemplary embodiment, the contextual information included in cyberattack forecast layer 280 of cyberthreat forecaster 250 comprises the adversary and target 281, along with the who 282 (e.g., threat actor identity), the what 283 (e.g., the type of cyberattack), the when 284 (e.g., the date or timing of the cyberattack), the where 285 (e.g., the location or identity of selected targets), the why 286 (e.g., the motivation or tactic animating the cyberattack), and the how 287 (e.g., the tactics, techniques and/or procedures used in the cyberattack) associated with a given forecasted cyberattack. The contextual information presented in FIG. 5 for cyberattack forecast layer 280 is only exemplary and may vary in other embodiments.

In this exemplary embodiment, the actionable guidance layer 290 of cyberthreat forecaster 250 generally includes recommend defensive measures 292 that are responsive to or informed by the cyberattack forecast layer 280 of cyberthreat forecaster 250. In some embodiments, the defensive measures 292 may include addressing or mitigating existing vulnerabilities identified in the technology estate in view of, for instance, the likelihood of future cyberattacks employing techniques and/or procedures that target said vulnerabilities. In certain embodiments, the defensive measures 292 are mapped to specific office location data 258 and/or industrial location data 259 based on the forecasted likelihood of those specific location data 258 and 259 being subject to future cyberattacks (e.g., the when 284 and where 285 of cyberattack forecast layer 280). In some embodiments, the defensive measures 292 may be based on forecasted trends in TTPs (e.g., the how 287 of cyberattack forecast layer 280) employed by threat actors such that defensive measures 292 may account for forecasted changes in the likelihood of the future employment of selected TTPs. In certain embodiments, the defensive measures 292 (and/or the parameters 281-287 of cyberattack forecast layer 280) may be iteratively adjusted to account for user-selected future changes to existing vulnerabilities to provide insight to the end-user of cyberthreat forecaster 250 of how changes to existing vulnerabilities and/or other changes to the technology estate data 257 may affect the outputs of layers 280 and/or 290 of cyberthreat forecaster 250.

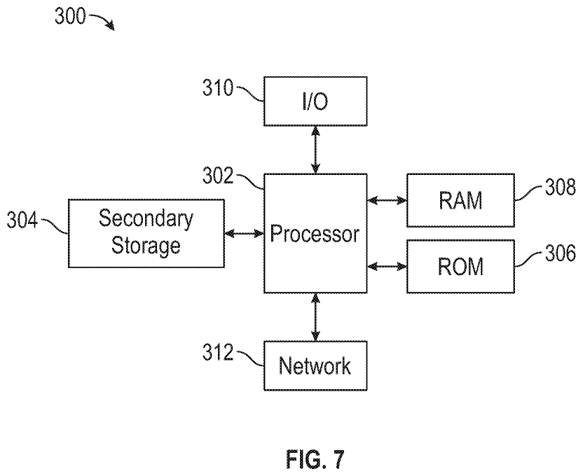

Referring now to FIG. 7, an embodiment of a computer system 300 is shown suitable for implementing one or more components disclosed herein. As an example, computer system 300 may be used to execute various embodiments of material testing systems (e.g., cyberthreat forecasters 40, 200, and 250 shown in FIGS. 1, 4, and 6) disclosed herein.

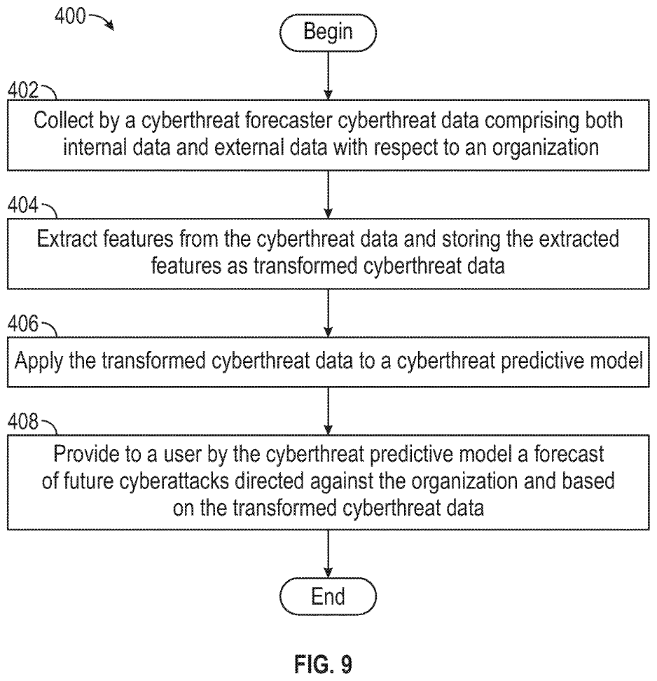

The computer system 300 of FIG. 9 generally includes a processor 302 that is in communication with memory devices including secondary storage 304, read only memory (ROM) 306, random access memory (RAM) 308, input/output (I/O) devices 310, and network connectivity devices 312. Processor 302 may be implemented as one or more central processing unit (CPU) chips and/or one or more graphics processing unit (GPU) chips. It is understood that by programming and/or loading executable instructions onto the computer system 300, at least one of the processors 302, the RAM 308, and the ROM 306 are changed, transforming the computer system 300 in part into a particular machine or apparatus having the novel functionality taught by the present disclosure.

Additionally, after the system 300 is turned on or booted, processor 302 may execute a computer program or application. For example, processor 302 may execute software or firmware stored in ROM 306 or stored in RAM 308. In some embodiments, at least some of the RAM 308 of system 300 comprises video random access memory (VRAM) usable by one or more GPU chips of the processor 302. In some cases, on boot and/or when the application is initiated, processor 302 may copy the application or portions of the application from the secondary storage 304 to the RAM 308 or to memory space within the processor 302 itself, and the processor 302 may then execute instructions that the application is comprised of. In some cases, processor 302 may copy the application or portions of the application from memory accessed via the network connectivity devices 312 or via the I/O devices 310 to the RAM 308 or to memory space within the processor 302, and the processor 302 may then execute instructions that the application is comprised of. During execution, an application may load instructions into processor 302, for example load some of the instructions of the application into a cache of processor 302. In some contexts, an application that is executed may be said to configure the processor 302 to do something, e.g., to configure the processor 302 to perform the function or functions promoted by the subject application. When the processor 302 is configured in this way by the application, processor 302 becomes a specific purpose computer or a specific purpose machine.

Secondary storage 304 may be used to store programs which are loaded into RAM 308 when such programs are selected for execution. The ROM 306 is used to store instructions and perhaps data which are read during program execution. ROM 306 is a non-volatile memory device which typically has a small memory capacity relative to the larger memory capacity of secondary storage 304. The secondary storage 304, the RAM 308, and/or the ROM 306 may be referred to in some contexts as computer readable storage media and/or non-transitory computer readable media. I/O devices 310 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 312 may take the form of modems, modem banks, Ethernet cards, universal serial bus (USB) interface cards, wireless local area network (WLAN) cards, radio transceiver cards, and/or other well-known network devices. The network connectivity devices 312 may provide wired communication links and/or wireless communication links. These network connectivity devices 312 may enable the processor 302 to communicate with the Internet or one or more intranets. With such a network connection, it is contemplated that processor 302 might receive information from the network or might output information to the network. Such information, which may include data or instructions to be executed using processor 302 for example, may be received from and outputted to the network, for example, in the form of a computer data baseband signal or signal embodied in a carrier wave.

The processor 302 executes instructions, codes, computer programs, scripts which it accesses from hard disk, floppy disk, optical disk, flash drive, ROM 306, RAM 308, or network connectivity devices 312. While only one processor 302 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 304, for example, hard drives, floppy disks, optical disks, and/or other device, the ROM 306, and/or the RAM 308 may be referred to in some contexts as non-transitory instructions and/or non-transitory information.

In an embodiment, the computer system 300 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

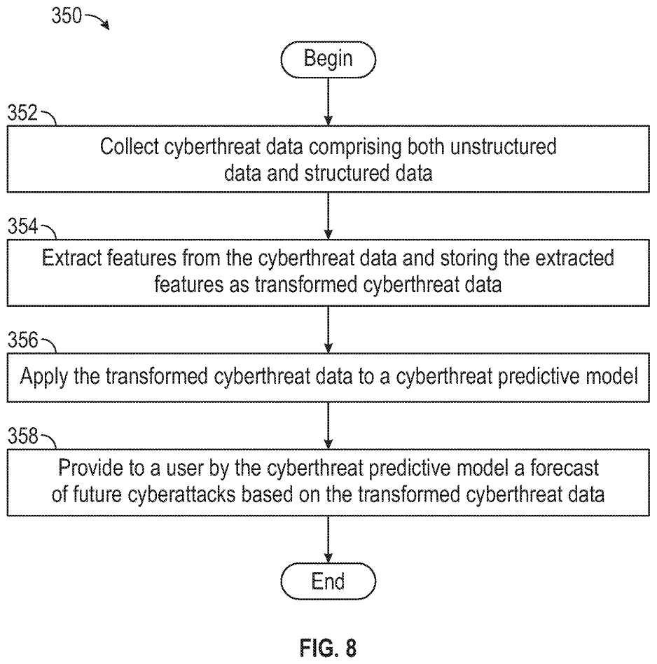

Referring to FIG. 8, an embodiment of a computer-implemented method 400 for forecasting future cyberthreats based on collected cyberthreat data is shown. Beginning at block 352, method 350 comprises collecting by a cyberthreat forecaster (e.g., cyberthreat forecasters 40, 200, and 250 shown in FIGS. 1, 4, and 6) cyberthreat data (e.g., cyberthreat data 32, 34, 36, and/or 38 shown in FIG. 1) comprising both unstructured data and structured data. At block 354, method 350 comprises extracting by the cyberthreat forecaster features (e.g., extracted features 175 shown in FIG. 3) from the cyberthreat data and storing the extracted features as transformed cyberthreat data.

At block 356, method 350 comprises applying by the cyberthreat forecaster the transformed cyberthreat data to a cyberthreat predictive model (e.g., cyberthreat predictive models 232 and 272 shown in FIGS. 4 and 6) of the cyberthreat forecaster. At block 358, method 350 comprises providing to a user by the cyberthreat predictive model a forecast of future cyberattacks (e.g., output data 234 and attack forecast layer 280 shown in FIGS. 4 and 6) based on the transformed cyberthreat data.

Referring to FIG. 9, another embodiment of a computer-implemented method 400 for forecasting future cyberthreats based on collected cyberthreat data is shown. Beginning at block 402, method 400 comprises collecting by a cyberthreat forecaster (e.g., cyberthreat forecasters 40, 200, and 250 shown in FIGS. 1, 4, and 6) cyberthreat data (e.g., cyberthreat data 32, 34, 36, and/or 38 shown in FIG. 1) comprising both internal data (e.g., collected from internal data sources 206) and external data (e.g., collected from external data sources 204) with respect to an organization (e.g., organization 1 shown in FIG. 1).

At block 404, method 400 comprises extracting by a cyberthreat forecaster features (e.g., extracted features 175 shown in FIG. 3) from the cyberthreat data and storing the extracted features as transformed cyberthreat data. At block 406, method 400 comprises applying by a cyberthreat forecaster the transformed cyberthreat data to a cyberthreat predictive model (e.g., cyberthreat predictive models 232 and 272 shown in FIGS. 4 and 6) of the cyberthreat forecaster. At block 408, method 400 comprises providing to a user by the cyberthreat predictive model a forecast of future cyberattacks (e.g., output data 234 and attack forecast layer 280 shown in FIGS. 4 and 6) directed against the organization and based on the transformed cyberthreat data.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps but rather, are used to simplify subsequent reference to such steps.

What is claimed is:

1. A computer-implemented method for forecasting future cyberthreats based on collected cyberthreat data, the method comprising:
(a) collecting, by a cyberthreat forecaster, cyberthreat data comprising both unstructured data and structured data;
(b) extracting, by the cyberthreat forecaster, features from the cyberthreat data and storing the extracted features as transformed cyberthreat data;
(c) applying, by the cyberthreat forecaster, the transformed cyberthreat data to a cyberthreat predictive model of the cyberthreat forecaster; and
(d) providing to a user by the cyberthreat predictive model a forecast of future cyberattacks based on the transformed cyberthreat data.

2. The method of claim 1, wherein the forecast of future cyberattacks comprises a total number of future cyberattacks across a user-selected time period.

3. The method of claim 1, wherein the forecast of future cyberattacks comprises a total number of future cyberattacks across a user-selected time period and directed against a user-selected organization.

4. The method of claim 1, wherein the forecast of future cyberattacks comprises a total number of future cyberattacks across a user-selected time period and employing at least one of a user-selected tactic, a selected technique, and a selected procedure.

5. The method of claim 1, wherein the forecast of future cyberattacks comprises a total number of future cyberattacks across a user-selected time period and directed against a user-selected location.

6. The method of claim 1, wherein the forecast of future cyberattacks comprises a total number of future cyberattacks across a user-selected time period and corresponding to a user-selected threat actor.

7. The method of claim 1, wherein the forecast of future cyberattacks comprises a total number of future cyberattacks across a user-selected time period and targeting a user-selected vulnerability.

8. The method of claim 1, further comprising:
(e) notifying the user of one or more defensive measures to address at least some of the forecasted future cyberattacks provided at (d).

9. The method of claim 1, wherein (b) comprises:
(b1) applying the unstructured data to a generative artificial intelligence (AI) model; and
(b2) generating by the generative AI model the extracted features from the unstructured data.

10. The method of claim 1, wherein (b) comprises:
(b1) applying the unstructured data to a retrieval augmented generation (RAG) model;
(b2) providing by the RAG model the unstructured data to a generative artificial intelligence (AI) model; and
(b3) generating by the generative AI model the extracted features from the unstructured data.

11. A computer-implemented method for forecasting future cyberthreats based on collected cyberthreat data, the method comprising:
(a) collecting, by a cyberthreat forecaster, cyberthreat data comprising both internal data and external data with respect to an organization;
(b) extracting, by a cyberthreat forecaster, features from the cyberthreat data and storing the extracted features as transformed cyberthreat data;
(c) applying, by a cyberthreat forecaster, the transformed cyberthreat data to a cyberthreat predictive model of the cyberthreat forecaster; and
(d) providing to a user by the cyberthreat predictive model a forecast of future cyberattacks directed against the organization and based on the transformed cyberthreat data.

12. The method of claim 11, wherein the internal data comprises historical data associated with past incidents of the organization and organizational data.

13. The method of claim 11, wherein the cyberthreat data comprises at least one of technical cyberthreat data, tactical cyberthreat data, operational cyberthreat data, and strategic cyberthreat data.

14. The method of claim 11, wherein the external data comprises one or more cyberthreat reports.

15. The method of claim 11, wherein the cyberthreat data comprises at least one of a tactic, a technique, and a procedure of a threat actor.

16. The method of claim 11, further comprising:
(e) notifying the user of one or more defensive measures to address at least some of the forecasted future cyberattacks provided at (d).

17. A computer-readable medium storing executable code which, when executed by a processor, causes the processor to:
(a) collect cyberthreat data comprising both unstructured data and structured data;
(b) extract features from the cyberthreat data and storing the extracted features as transformed cyberthreat data;
(c) apply the transformed cyberthreat data to a cyberthreat predictive model; and
(d) provide to a user by the cyberthreat predictive model a forecast of future cyberattacks based on the transformed cyberthreat data.

18. The computer-readable medium of claim 17, wherein the forecast of future cyberattacks comprises a total number of future cyberattacks across a user-selected time period.

19. The computer-readable medium of claim 17, wherein the forecast of future cyberattacks comprises a total number of future cyberattacks across a user-selected time period and directed against a user-selected organization.

20. The computer-readable medium of claim 17, wherein the executable code, when executed by the processor, causes the processor to:
(e) notify the user of one or more defensive measures to address at least some of the forecasted future cyberattacks provided at (d).
